(19) United States
(12) Patent Application Publication
(10) Pub. No.: US 2016/0180417 A1
(43) Pub. Date: Jun. 23, 2016

(54) PROVIDING A GIFTING USER ACCESS TO A GIFT RECIPIENT'S PERSONAL E-BOOK INFORMATION

(71) Applicant: Kobo Incorporated, Toronto (CA)

(72) Inventor: Vanessa GHOSH, Toronto (CA)

(73) Assignee: Kobo Incorporated, Toronto (CA)

(21) Appl. No.: 14/575,723

(22) Filed: Dec. 18, 2014

(51) Int. Cl. G06Q 30/06

(52) U.S. Cl. CPC G06Q 30/0601

(57) ABSTRACT

Methods and systems for providing a gifting user access to a gift recipient's personal e-Book information are provided. A distinct gesture is correlated with each of a plurality of e-Book recipients. Determining when the distinct gesture correlated with one of the plurality of e-Book recipients is performed on at least one e-Book in an e-Bookstore. Automatically placing the at least one e-Book identified by the distinct gesture correlated with one of the plurality of e-Book recipients into a portion of a shopping multi-cart designated for the one of the plurality of e-Book recipients.

### TECHNICAL FIELD

Examples described herein relate to providing a gifting user access to a gift recipient's personal e-Book information.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-reading devices) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reading device) devices typically link to an online bookstore, and media playback devices often include applications that enable the user to access an online median electronic library (or e-Library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-Book services on a computing device, in an embodiment.

FIG. 2 illustrates a example architecture configuration of a computing device, according to an embodiment.

FIG. 3 illustrates a block diagram of a gift recipient's e-Bookstore gift page on an e-reading device, according to an embodiment.

FIG. 4 illustrates a block diagram of a gift recipient's e-Library, according to an embodiment.

FIG. 5 illustrates a method of implementing providing a gifting user access to a gift recipient's personal e-Book information, according to an embodiment.

FIG. 6 illustrates an exemplary computer system for implementing providing a gifting user access to a gift recipient's personal e-Book information, according to an embodiment.

### DETAILED DESCRIPTION

Methods and systems for providing a gifting user access to a gift recipient's personal e-Book information are disclosed. That is, one embodiment enables a user seeking to purchase one or more e-Books for a gift recipient to access book recommendations for that recipient, via the recipient's e-Bookstore home page or e-Library. In one embodiment, by accessing the gift recipient's e-Bookstore home page or e-Library, the user can view the gift recipient's ratings of books, book reviews, e-Books searches and the like. In so doing, the user can utilize the gift recipient's e-Book related personalized information to help guide the user in the selection of an e-Book gift for the gift recipient.

In one embodiment, before the user can access the gift recipient's e-Bookstore home page or e-Library, the gifting user adds the recipient user's account as a “giftee”. The gift recipient then receives a notification asking whether they would like to share information with the gifting user. In one embodiment, the sharing of information may include a specified time period. For example the gift recipient can provide the user access to the gift recipient's e-Bookstore home page or e-Library for a period of a week. In another embodiment, the gift recipient can provide the user access to the gift recipient's e-Bookstore home page or e-Library on a reoccurring schedule, such as a birthday month, holiday period, or the like.

In addition to providing a gifting user access to a gift recipient's e-Bookstore home page or e-Library; one embodiment allows the user to make a purchase from the gift recipients e-Bookstore gift page, such that payment is provided by the gifting user's account but the purchased e-Book will be associated with the gift recipient's e-Library.

In general, “E-Books” are a form of electronic publication content stored in digital format in a computer non-transitory memory, viewable on a computing device having display functionality. An e-Book can correspond to, or mimic, the paginated format of a printed publication for viewing, such as provided by printed literary works (e.g., novels) and periodicals (e.g., magazines, comic books, journals, etc.). Optionally, some e-Books may have chapter designations, as well as content that corresponds to graphics or images (e.g., such as in the case of magazines or comic books).

Multi-function devices, such as cellular-telephony or messaging devices, can utilize specialized applications e.g., specialized e-reading application software) to view e-Books in a format that mimics the paginated printed publication. Still further, some devices (sometimes labeled as “e-reading devices”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

“e-reading device”, variously referred to herein as an electronic personal display or mobile computing device, can refer to any computing device that can display or otherwise render an e-Book. By way of example, an e-reading device can include a mobile computing device on which an e-reading application can be executed to render content that includes e-Books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reading device, such as a purpose-built device that is optimized for an e-reading experience (e.g., with E-ink displays).

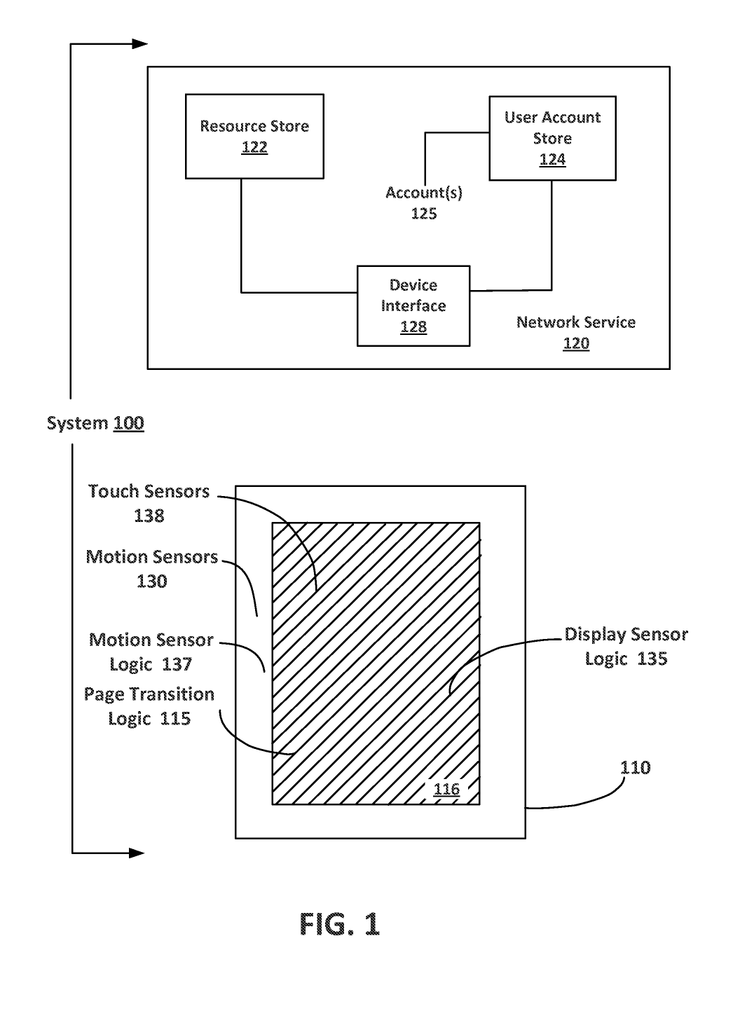

FIG. 1 illustrates a system 100 for utilizing applications and providing e-Book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network. service 120 can provide e-Book services that communicate with the e-reading device 110. The e-Book services provided through network service 120 can, for example, include services in which e-Books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-Books, media files, documents) can be rendered and consumed. For example, the e-reading device 110 can correspond to a tablet or telephony/messaging device (e.g., smart phone). In one implementation, for example, e-reading device 110 can run an e-reading device application that links the device to the network service 120 and enables e-Books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-Books), For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-Books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-Books and content items are associated with the user device. Additionally, the device interface 128 can provide the e-reading device 110 with access to the resource store 122, which can include, for example, an online store, The device interface 128 can handle input to identify content items (e.g., e-Books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-Books) that are purchased or otherwise made available to the user of the e-reading device 110, as well as to archive e-Books and other digital content items that have been purchased for the user account 125, but are not stored on the particular computing device.

With reference to an example of FIG. 1, e-reading device 110 can include a display 116 and an optional housing, not shown. in an embodiment, the display 116 is touch-sensitive, to process touch inputs including gestures (e.g., swipes). For example, the display 116 may be integrated with one or more touch sensors 138 to provide a touch-sensing region on a surface of the display 116. For some embodiments, the one or more touch sensors 138 may include capacitive sensors that can sense or detect a human body's capacitance as input. In the example of FIG. 1, the touch sensing region coincides with a substantial surface area, if not all, of the display 116. Additionally, the housing can be integrated with touch sensors to provide one or more touch sensing regions, for example, on the bezel and/or back surface of the housing.

E-reading device 110 can also optionally include one or more motion sensors 130 arranged to detect motion imparted thereto, such as by a user while reading or in accessing associated functionality. In general, the motion sensor(s) 130 may be selected from one or more of a number of motion recognition sensors, such as but not limited to, an accelerometer, a magnetometer, a gyroscope and a camera. Further still, motion sensor 130 may incorporate or apply some combination of the latter motion recognition sensors.

E-reading device 110 further includes motion sensor logic 137 to interpret user input motions as commands based on detection of the input motions by motion sensor(s) 130. For example, input motions performed on e-reading device 110 such as a tilt, a shake, a rotation, a swivel or partial rotation and an inversion may be detected via motion sensors 130 and interpreted as respective commands by motion sensor logic 137.

In some embodiments, the e-reading device 110 includes features for providing functionality related to displaying paginated content. The e-reading device 110 can include page transitioning logic 115, which enables the user to transition through paginated content. The e-reading device 110 can display pages from e-Books, and enable the user to transition from one page state to another. In particular, an e-Book can provide content that is rendered sequentially in pages, and the e-Book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state In the specific example embodiment where a given page state coincides with a single page, for instance, each page state corresponding to one page of the digitally constructed series of pages paginated to comprise, in one embodiment, an e-Book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. in one implementation, the user can signal a page transition event to transition page states by, for example, interacting with the touch-sensing region of the display 116. For example, the user may swipe the surface of the display 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state.

For example, a user can touch and hold the surface of the display 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display 116. Although discussed in context of “taps” herein, it is contemplated that a gesture action provided in sufficient proximity to touch sensors of display 116, without physically touching thereon, may also register as a “contact” with display 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display 116, otherwise known as a touch event. More specifically, display sensor logic 135 can detect a touch events also referred to herein as a tap, an initial tap held in contact with display 116 for longer than some pre-defined threshold duration of time (otherwise known as a “long press” or a “long touch”), multiple taps performed either sequentially or generally simultaneously, swiping gesture actions made through user interaction with the touch sensing region of the display 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

The term “sustained touch” is also used herein and refers to a touch event that is held in sustained contact with display 116, during which sustained contact period the user or observer may take additional input actions, including gestures, on display 116 contemporaneously with the sustained contact. Thus a long touch is distinguishable from a sustained touch, in that the former only requires a touch event to be held for some pre-defined threshold duration of time, upon expiration of which an associated input command may be automatically triggered.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display 116 for the purpose of associating respective input commands therewith.

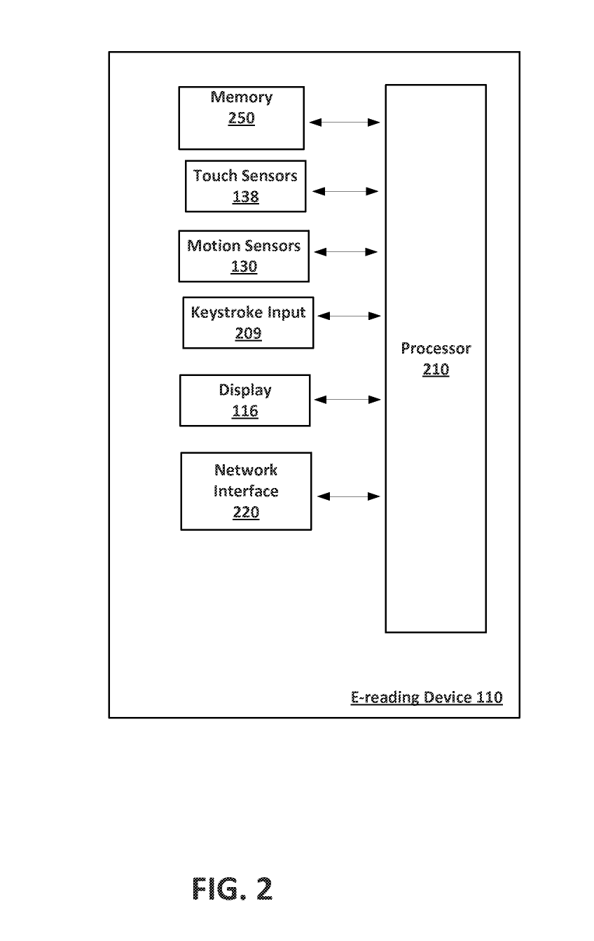

FIG. 2 illustrates further detail of e-reading device 110 as described above with respect to FIG. 1, in an embodiment. E-reading device 110 further includes processor 210, a memory 250 storing instructions and logic pertaining at least to display sensor logic 135, and page transition logic 115.

Processor 210 can implement functionality using the logic and instructions stored in memory 250. Additionally, in some implementations, processor 210 utilizes the network interface 220 to communicate with the network service 120 (see FIG. 1). More specifically, the e-reading device 110 can access the network service 120 to receive various kinds of resources (e.g., content items such as e-Books, configuration files, account information), as well as to provide information (e.g., user account information, service requests etc.). For example, e-reading device 110 can receive application resources, such as e-Books or media files, that the user elects to purchase or otherwise download via the network service 120. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can optionally receive input from various sources, including touch sensor components 138, display 116, keystroke input 209 such as from a virtual or rendered keyboard, and other input mechanisms (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-Book activities such as generating e-Book content on display 116, performing page transitions of the displayed e-Book content, powering off the e-reading device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

In one embodiment, network interface 220 of e-reading device 110 includes wireless connectivity subsystems, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of the wireless connectivity subsystems of network interface 220 depends on the communication network in which e-reading device 110 is intended to operate, such as in accordance with Wi-Fi, Bluetooth, Near Field Communication (WC) communication protocols, and the like.

Display 116 of e-reading device 110 includes touch functionality whereby user input commands may be accomplished via gesture actions performed at display 116. In the context of reading digitally rendered pages comprising content of an e-Book, for example, come common input commands accomplished via gesture actions received at display 116 may include, for example, page turns, making annotations, adjusting illumination levels or contrast of the device display screen, and re-sizing the font size of text in the content.

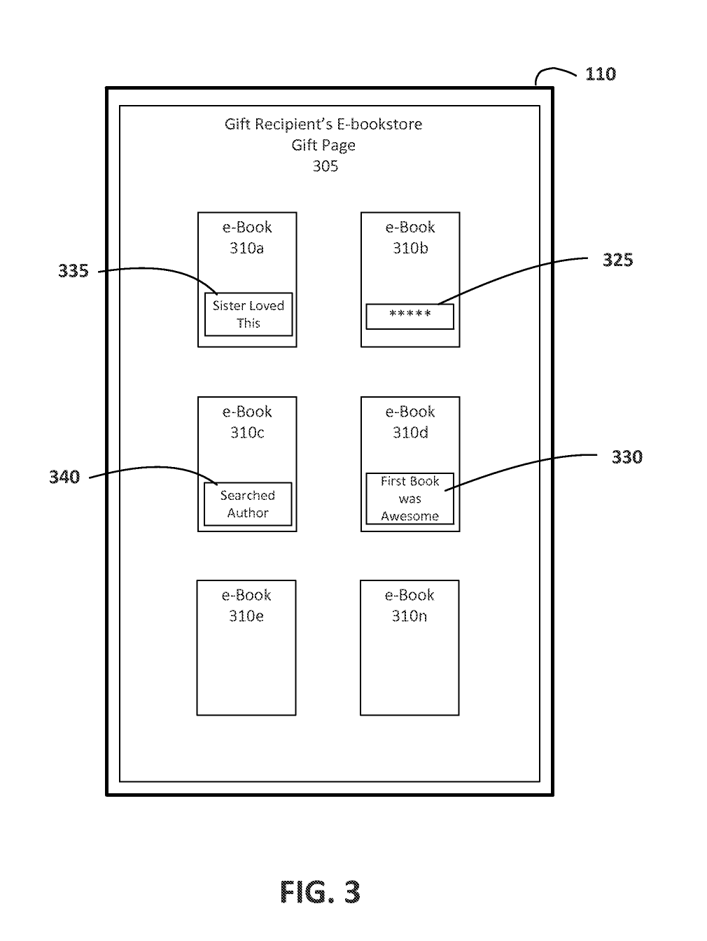

FIG. 3 illustrates a block diagram of a gift recipient's e-Bookstore gift page 305 on an e-reading device 110, according to an embodiment. In one embodiment, gift recipient's e-Bookstore gift page 305 is a page in an e-Bookstore that shows a number of e-Book selections such as, e-Book 310a-310n. Although FIG. 300 shows e-Book 310a-310n, it should be appreciated that e-Book 310a-310n may be any e-readable types, such as but not limited to, an e-novel, an e-magazine, an e-comic, a PDF, a scholarly article, and the like. In addition to showing e-Books, gift recipient's e-Bookstore gift page 305 may also include an e-Book rating 325, a review 330, a recommendation 335, a result from a prior e-Book search 340, an e-Book in the gift recipient's e-Library 405, and the like.

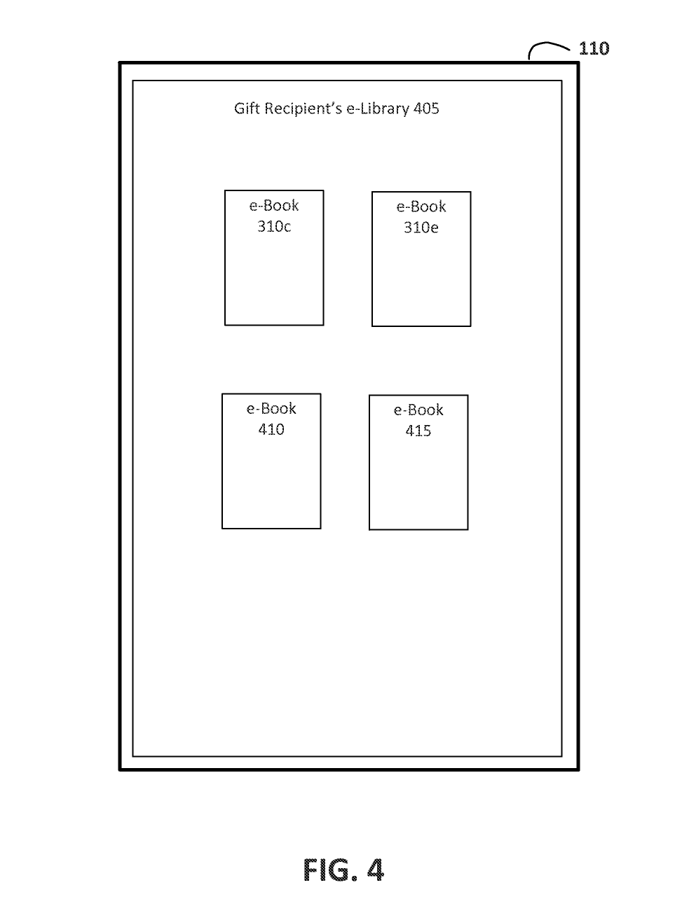

FIG. 4 illustrates a block diagram of a gift recipient's e-Library 405, according to an embodiment. in one embodiment, gift recipient's e-Library 405 includes all of the e-Books in the gift recipient's library including any of the new e-Books that were gifted to the gift recipient. For example, in the example figure of gift recipient's e-Library 405, e-Book 310c and e-Book 310e are newly gifted and added to the gift recipient's previously existing collection that included e-Book 410 and e-Book 415.

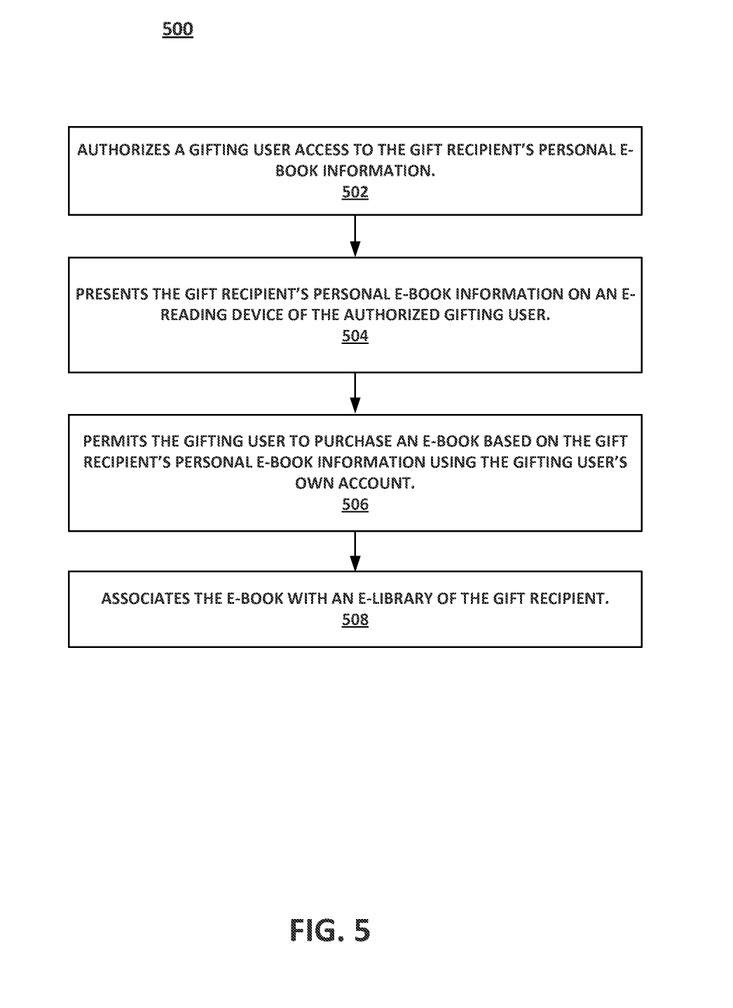

FIG. 5 illustrates a method 500 of implementing providing a gifting user access to a gift recipient's personal e-Book information, according to an embodiment. For example, in one embodiment, by accessing the gift recipient's e-Bookstore home page or e-Library, the user can view the gift recipient's e-Book rating 325, review 330, recommendation 335, result from a prior e-Book search 340, an e-Book in the gift recipient's e-Library 405, and the like. In so doing, the user can utilize the gift recipient's e-Book related personalized information to help in the selection of an e-Book gift. in general, the e-Book may be, but is not limited to, an e-novel, an e-magazine, an e-comic book, a PDF, and a scholarly article.

Referring now to 502 of FIG. 5 and to FIG. 3, one embodiment authorizes a gifting user access to the gift recipient's personal e-Book information. For example, a personalized e-Book information authorizer such as network interface 220 may authorize a gifting user access to the gift recipient's personal e-Book information. However, in one embodiment, before the gifting user can access the gift recipient's e-Bookstore gift page 305 or e-Library 405, the gifting user adds the recipient user's account as a “giftee”. The gift recipient then receives a notification asking whether they would like to share information with the gifting user. For example: John Doe would like to add you as a giftee. Do you accept?

In one embodiment, the authorizing a gifting user access to the gift recipient's personal e-Book information for a predefined time period or at a recurring interval or recurring schedule. For example, the gift recipient can authorize the user access to the gift recipient's personal e-Book information for a period of a week. In another embodiment, the gift recipient can provide the user access to the gift recipient's personal e-Book information on a reoccurring schedule, such as during the gift recipient's birthday month, for a given holiday period, or the like.

With reference now to 504 of FIG. 5 and to FIGS. 3 and 4, one embodiment presents the gift recipient's personal e-Book information on an e-reading device 110 of the authorized gifting user. For example, a personal e-Book information provider, such as user account store 124, may present the personal e-Book information in association with the gift recipient's e-Bookstore gift page 305 or the gift recipient's e-Library 405. In one embodiment, the gift recipient's personal e-Book information includes, but is not limited to, an e-Book rating 325, an e-Book review 330, a received e-Book recommendation 335, a result from a prior e-Book search 340, an e-Book in the gift recipient's e-Library 405, and the like.

With reference now to 506 of FIG. 5 and to FIGS. 3 and 4, one embodiment permits the gifting user to purchase an e-Book based on the gift recipient's personal e-Book information using the gifting user's own account. in one embodiment, a gift purchase provider such as account 125 is used by the gifting user to purchase the e-Book. In other words, one embodiment allows the gifting user to make a purchase from the gift recipient's e-Bookstore gift page 305, such that payment is provided by the gift giving user's account.

For example, e-Book 310c and e-Book 310e are purchased from the gift recipient's e-Bookstore gift page 305. The payment for the e-Books would be associated with, e.g., debited from. or invoiced to, the gifting user's account even though the gifting user was accessing the gift recipient's e-Bookstore gift page 305.

With reference now to 508 of FIG. 5 and to FIG. 4, one embodiment associates the e-Book with an e-Library of the gift recipient. That is, the gift purchase provider associates the purchased e-Book with the gift recipient's e-Library 405. For example the purchased e-Book 310c and e-Book 310e will become available to the gift recipient via the gift recipient's e-Library 405 as shown in FIG. 4.

### Example Computer System Environment

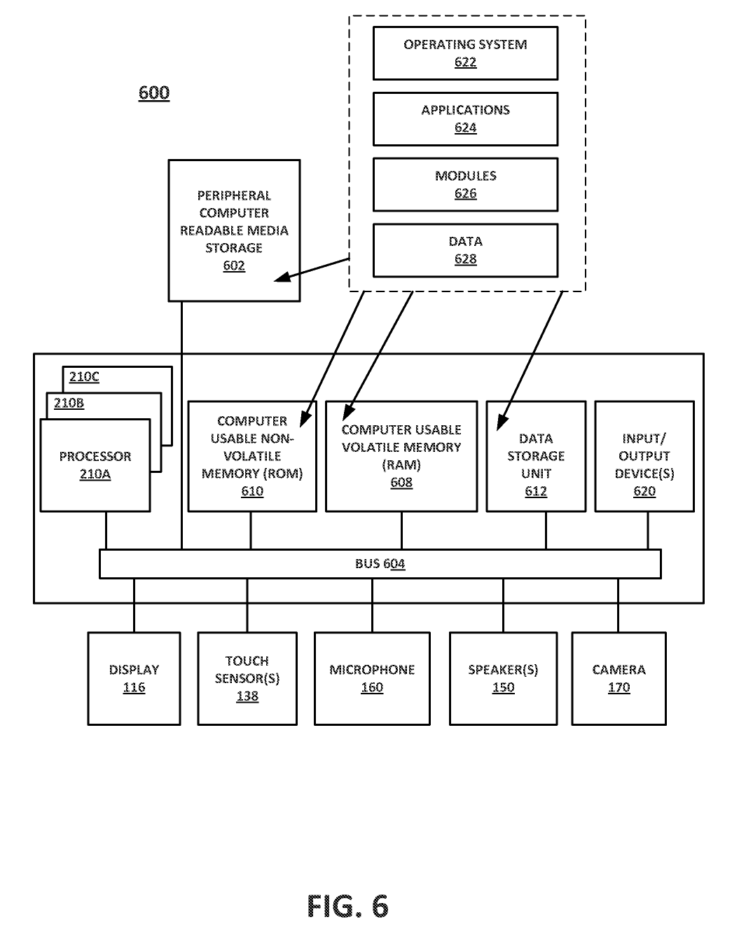

With reference now to FIG. 6, all or portions of some embodiments described herein are composed of computer-readable and computer-executable instructions that reside, for example, in computer-usable/computer-readable storage media of a computer system. That is, FIG. 6 illustrates one example of a type of computer system 600 that can be used in accordance with or to implement various embodiments of an e-reading device, such as e-reading device 110, which are discussed herein. It is appreciated that computer system 600 of FIG. 6 is only an example and that embodiments as described herein can operate on or within a number of different computer systems.

System 600 of FIG. 6 includes an address/data bus 604 for communicating information, and a processor 210A coupled to bus 604 for processing information and instructions. As depicted in FIG. 6, computer system 600 is also well suited to a multi-processor environment in which a plurality of processors 210A, 210B, and 210C are present. Processors 210A, 210B, and 210C may be any of various types of microprocessors. For example, in some multi-processor embodiments, one of the multiple processors may be a touch sensing processor and/or one of the processors may be a display processor. Conversely, computer system 600 is also well suited to having a single processor such as, for example, processor 210A.

System 600 also includes data storage features such as a computer usable volatile memory 608, e.g., random access memory (RAM), coupled to bus 604 for storing information and instructions for processors 210A, 210B, and 210C. System 600 also includes computer usable non-volatile memory 610, e.g., read only memory (ROM), coupled to bus 604 for storing static information and instructions for processors 210A, 210B, and 210C. Also present in computer system 600 is a data storage unit 612 (e.g., a magnetic or optical disk and disk drive) coupled to bus 604 for storing information and instructions.

Computer system 600 of FIG. 6 is well adapted to having peripheral computer-readable storage media 602 such as, for example, a floppy disk, a compact disc, digital versatile disc, universal serial bus “flash” drive, removable memory card, and the like coupled thereto. In some embodiments, computer-readable storage media 602 may be coupled with computer system 600 (e.g., to bus 604) by insertion into removable a storage media slot.

System 600 also includes or couples with display 116 for visibly displaying information such as alphanumeric text and graphic images. In some embodiments, computer system 600 also includes or couples with one or more optional touch sensors 138 for communicating information, cursor control, gesture input, command selection, and/or other user input to processor 210A or one or more of the processors in a multi-processor embodiment. In some embodiments, computer system 600 also includes or couples with one or more optional speakers 150 for emitting audio output. In some embodiments, computer system 600 also includes or couples with an optional microphone 160 for receiving/capturing audio inputs. In some embodiments, computer system 600 also includes or couples with an optional digital camera 170 for receiving/capturing digital images as an input,

Optional touch sensor(s) 138 allows a user of computer system 600 (e.g., a user of an eReader of which computer system 600 is a part) to dynamically signal the movement of a visible symbol (cursor) on display 116 and indicate user selections of selectable items displayed. in some embodiment other implementations of a cursor control device and/or user input device may also be included to provide input to computer system 600, a variety of these are well known and include: trackballs, keypads, directional keys, and the like.

System 600 is also well suited to having a cursor directed or user input received by other means such as, for example, voice commands received via microphone 160. System 600 also includes an input/output (I/O) device 620 for coupling computer system 600 with external entities. For example, in one embodiment, I/O device 620 is a modem for enabling wired communications or modem and radio for enabling wireless communications between computer system 600 and an external device and/or external network such as, but not limited to, the Internet. I/O device 620 may include a short-range wireless radio such as a Bluetooth® radio, Wi-Fi radio (e.g., a radio compliant with Institute of Electrical and Electronics Engineers' (IEEE) 802.11 standards), or the like.

Referring still to FIG. 6, various other components are depicted for computer system 600. Specifically, when present, an operating system 622, applications 624, modules 626, and/or data 628 are shown as typically residing in one or some combination of computer usable volatile memory 608 (e.g., RAM), computer usable non-volatile memory 610 (e.g., ROM), and data storage unit 612. For example, modules 626 may include an application module for providing an image based decision platform for a user.

In some embodiments, all or portions of various embodiments described herein are stored, for example, as an application 624 and/or module 626 in memory locations within RAM 608, ROM 610, computer-readable storage media within data storage unit 612, peripheral computer-readable storage media 602, and/or other tangible computer readable storage media.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A system for providing a gifting user access to a gift recipient's persona e-Book information comprising:
a personalized e-Book information authorizer to authorize a gifting user access to the gift recipient's personal e-Book information;
a personal e-Book information provider to present the gift recipient's personal e-Book information on an e-reading device of the authorized gifting user; and
a gift purchase provider to allow the gifting user to purchase an e-Book based on the gift recipient's personal e-Book information using a gifting user's own account and associate the e-Book with an e-Library of the gift recipient.

2. The system of claim 1 wherein the personalized e-Book information authorizer receives a request for access from the gifting user.

3. The system of claim 1 wherein the personalized e-Book information authorizer only authorizes the gifting user access to the gift recipient's personal e-Book information for a predefined time period.

4. The system of claim 1 wherein the personalized e-Book information authorizer only authorizes the gifting user access to the gift recipient's personal e-Book information for a predefined time period on a recurring schedule.

5. The system of claim 1 wherein the gift recipient's personal e-Book information includes information selected from the group consisting of: an e-Book rating, an e-Book review, a received e-Book recommendation, a result from a prior e-Book search, an e-Book in the e-Library of the gift recipient.

6. The system of claim 1 wherein the personal e-Book information provider additionally (presents the e-Library of the gift recipient on the e-reading device of the authorized gifting user.

7. The system of claim 1 wherein the e-Book is selected from the group consisting of: an e-novel, an e-magazine, an e-comic book, a PDF, and a scholarly article.

8. A computing device comprising:
a memory that stores a set of instructions;
a display screen having touch functionality;
a processor that access the instructions in memory, the processor further configured to implement a method for providing a gifting user access to a gift recipient's personal e-Book information comprising:
authorizing a gifting user access to the gift recipient's personal e-Book information;
presenting the gift recipient's personal e-Book information on an e-reading device of the authorized gifting user; user;
permitting the gifting user to purchase an e-Book based on the gift recipient's personal e-Book information using a gifting user's own account; and
associating the e-Book with an e-Library of the gift recipient.

9. The computing device of claim 8 further comprising:
receiving a request for access to the gift recipient's personal e-Book information from the gifting user prior to authorizing the gifting user access to the gift recipient's personal e-Book information.

10. The computing device of claim 8 further comprising:
authorizing a gifting user access to the gift recipient's personal e-Book information for a predefined time period.

11. The computing device of claim 8 further comprising:
authorizing a gifting user access to the gift recipient's personal e-Book information for a predefined time period on a recurring schedule.

12. The computing device of claim 8 wherein the gift recipient's personal e-Book information includes information selected from the group consisting of: an e-Book rating, an e-Book review, a received e-Book recommendation, a result from a prior e-Book search, an e-Book in the e-Library of the gift recipient.

13. The computing device of claim 8 further comprising:
presenting the e-Library of the gift recipient on the e-reading device of the authorized gifting user.

14. The computing device of claim 8 wherein the e-Book is selected from the group consisting of: an e-novel, an e-magazine, an e-comic book, a PDF, and a scholarly article.

15. A non-transitory computer implemented method for providing a gifting user access to a gift recipient's personal e-Book information, said method comprising:
receiving a request for access to a gift recipient's personal e-Book information from a gifting user;
authorizing the gifting user access to the gift recipient's personal e-Book information;
presenting the gift recipient's personal e-Book information on an e-reading device of the authorized gifting user; user;
permitting the gifting user to purchase an e-Book based on the gift recipient's personal e-Book information using a gifting user's own account; and
associating the e-Book with an e-Library of the gift recipient.

16. The non-transitory computer implemented method of claim 15 further comprising:
authorizing a gifting user access to the gift recipient's personal e-Book information for predefined time period.

17. The non-transitory computer implemented method of claim 15 further comprising:
authorizing a gifting user access to the gift recipient's personal e-Book information for a predefined time period on a recurring schedule.

18. The non-transitory computer implemented method of claim 15 wherein the gift recipient's personal e-Book information includes information selected from the group consisting of: an e-Book rating, an e-Book review, a received e-Book recommendation, a result from a prior e-Book search, an e-Book in the e-Library of the gift recipient.

19. The non-transitory computer implemented method of claim 15 further comprising:
presenting the e-Library of the gift recipient on the e-reading device of the authorized gifting user.

20. The non-transitory computer implemented method of claim 15 wherein the e-Book is selected from the group consisting of: an e-novel, an e-magazine, an e-comic book, a PDF, and a scholarly article.
